(19) United States
(12) Patent Application Publication
(10) Pub. No.: US 2025/0384518 A1
(43) Pub. Date: Dec. 18, 2025

(54) GRAPHICS CARD

(71) Applicant: ASUS GLOBAL PTE. LTD., Singapore (SG)

(72) Inventor: Fang-Ping YUAN, Singapore (SG)

(21) Appl. No.: 18/944,432

(22) Filed: Nov. 12, 2024

(30) Foreign Application Priority Data
Jun. 12, 2024 (CN) 202410756553.3

(51) Int. Cl. G06T 1/20

(52) U.S. Cl. CPC G06T 1/20

(57) ABSTRACT

A graphics card is provided, including a graphics processing unit, a graphics card connector, an interface device, and a switching element. The graphics card connector is adapted to be connected to a motherboard. The graphics card connector supports a first bus standard, and includes a first pin group. The interface device is adapted to be connected to a mobile device to receive first data that follows a second bus standard, and convert the first data into second data that follows the first bus standard. The switching element is electrically coupled to a conversion element, the first pin group, and the graphics processing unit, and is adapted to selectively conduct a data transmission path between the conversion element and the graphics processing unit or a data transmission path between the first pin group and the graphics processing unit.

### CROSS-REFERENCE TO RELATED APPLICATION

This application claims the priority benefit of Chinese Application Serial No. 202410756553.3, filed on Jun. 12, 2024. The entirety of the above-mentioned patent application is hereby incorporated by reference herein and made a part of the specification.

### BACKGROUND OF THE INVENTION

### Field of the Invention

The disclosure relates to a graphics card.

### Description of the Related Art

A discrete graphics card is independent hardware dedicated to processing graphics work, and is generally applicable to a desktop computer, to provide functional improvement in display. In addition to the general discrete graphics card, an external graphics card applicable to a notebook computer is also available on the market, which is adapted to provide performance improvement in display.

However, the existing discrete graphics card is applicable to only the desktop computer, and cannot be directly connected to the notebook computer as an external graphics card for use.

### BRIEF SUMMARY OF THE INVENTION

The disclosure provides a graphics card, including a graphics processing unit (GPU), a graphics card connector, an interface device, a conversion element, and a switching element. The graphics card connector is adapted to be plugged into a motherboard. The graphics card connector supports a first bus standard, and includes a first pin group.

The interface device includes a mobile device connector and the conversion element. The mobile device connector is adapted to be connected to a mobile device. The mobile device connector supports a second bus standard, and is adapted to receive first data. The conversion element is electrically coupled to the mobile device connector, and is adapted to convert the first data into second data. The second data follows the first bus standard. A quantity of transmission channels of the first bus standard that are supported by the conversion element is equal to a quantity of transmission channels supported by the first pin group.

The switching element is electrically coupled to the conversion element, the first pin group, and the graphics processing unit, and is adapted to selectively conduct a data transmission path between the conversion element and the graphics processing unit or a data transmission path between the first pin group and the graphics processing unit.

The graphics card provided by the disclosure includes the conversion element, adapted to convert the first data that is from an external device and follows the second bus standard into the second data that follows the first bus standard, and includes the switching element that selectively conducts the data transmission path between the conversion element and the graphics processing unit or the data transmission path between the first pin group and the graphics processing unit. In this way, based on a use requirement, the graphics card is used with a desktop computer as a discrete graphics card, or is used with a notebook computer as an external graphics card, so that a plurality of graphics card devices does not need to be prepared for different use scenarios.

### BRIEF DESCRIPTION OF THE DRAWINGS

FIG. 1 is a schematic block diagram of a graphics card according to an embodiment of the disclosure;

FIG. 2 is a schematic block diagram of an interface device according to an embodiment of the disclosure;

FIG. 3 is a schematic block diagram of a graphics card according to another embodiment of the disclosure; and

FIG. 4 is a schematic block diagram of a graphics card according to still another embodiment of the disclosure.

### DETAILED DESCRIPTION OF THE EMBODIMENTS

Specific embodiments of the disclosure are described in detail below with reference to schematic diagrams. Advantages and features of the disclosure are clearer from the following descriptions and the claims. It is to be noted that, the accompanying drawings are drawn by using an extremely simplified form and imprecise proportion, which are only used for conveniently and clearly assisting in explaining the objective of the embodiments of the disclosure.

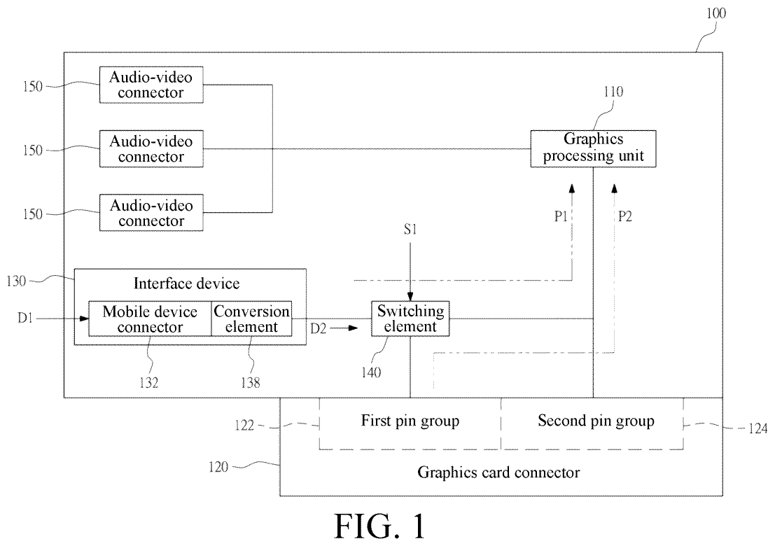

FIG. 1 is a schematic block diagram of a graphics card 100 according to an embodiment of the disclosure.

The graphics card 100 includes a graphics processing unit (GPU) 110, a graphics card connector 120, an interface device 130, a switching element 140, and at least one audio-video connector 150 (where three audio-video connectors 150 are shown in the figure).

The graphics card connector 120 is adapted to be connected to a motherboard (not shown in the figure), and supports a first bus standard. In an embodiment, the first bus standard is peripheral component interconnect express (PCI-E).

A quantity of transmission channels supported by the graphics card connector 120 is a first quantity, and pins of the graphics card connector 120 are divided into a first pin group 122 and a second pin group 124. A quantity of transmission channels supported by the first pin group 122 is a second quantity, and the first quantity is greater than the second quantity. In other words, a quantity of transmission channels corresponding to the second pin group 124 is a difference between the first quantity and the second quantity.

In an embodiment, the second quantity is 4, and the first quantity is 16. When the graphics card connector 120 is a peripheral component interconnect express (PCI-E) connector, the graphics card connector 120 is a connector of PCI-E X16. The first pin group 122 corresponds to pins of connection interfaces of PCI-E X4, and supports bandwidth of the PCI-E X4. The second pin group 124 corresponds to pins of the remaining 12 transmission channels, and supports bandwidth of PCI-E X12.

In the disclosure, connection manners of the first pin group 122 and the second pin group 124 of the graphics card connector 120 are different. The first pin group 122 is indirectly electrically coupled to the graphics processing unit 110 through the switching element 140. The second pin group 124 is directly electrically coupled to the graphics processing unit 110.

The interface device 130 includes a mobile device connector 132 and a conversion element 138. The mobile device connector 132 supports a second bus standard. The mobile device connector 132 is adapted to be connected to a mobile device (not shown in the figure), and receive first data D1 from the mobile device. The first data D1 is audio-video data following a standard of a universal serial bus (USB). In an embodiment, the second bus standard is universal serial bus (USB). In an embodiment, the mobile device connector 132 is a USB4 connector, a thunderbolt connector, or an OCuLink connector, and the mobile device connector 132 is a slot. In an embodiment, the interface device 130 includes at least one universal serial bus Type-C connector.

The conversion element 138 is electrically coupled to the mobile device connector 132, and is adapted to convert the first data D1 following the second bus standard into second data D2 following the first bus standard. A quantity of transmission channels of the first bus standard that correspond to (are supported by) the conversion element 138 and the quantity of transmission channels of the first bus standard that correspond to (are supported by) the first pin group 122 are the same, and are both the second quantity.

Conversion of a general bus transmission signal, in an embodiment, converting a universal serial bus (USB) signal into a peripheral component interconnect express (PCI-E) signal, currently exists in the art, and is not a key point of the disclosure. Details are not described herein.

The switching element 140 is electrically coupled to the conversion element 138, the first pin group 122, and the graphics processing unit 110, and is adapted to selectively conduct a data transmission path P1 between the conversion element 138 and the graphics processing unit 110 or a data transmission path P2 between the first pin group 122 and the graphics processing unit 110.

In an embodiment, the graphics card 100 is manually switched or automatically switches between a first operation mode and a second operation mode based on a selection signal S1. The first operation mode is a desktop operation mode, and the second operation mode is a mobile operation mode.

When the graphics card 100 operates in the first operation mode, the switching element 140 conducts the data transmission path P2 between the first pin group 122 and the graphics processing unit 110. In this case, the graphics processing unit 110 communicates with the motherboard through the graphics card connector 120. In other words, the graphics card 100 is used with a computer device, in an embodiment, a desktop computer, as a discrete graphics card.

When the graphics card 100 operates in the second operation mode, the switching element 140 conducts the data transmission path P1 between the conversion element 138 and the graphics processing unit 110. In this case, the graphics processing unit 110 communicates with a mobile device, in an embodiment, a notebook computer, through the interface device 130. In other words, the graphics card 100 is used with a computer device, in an embodiment, a notebook computer, as an external graphics card.

The audio-video connector 150 is electrically coupled to the graphics processing unit 110, and is adapted to transmit an audio-video signal generated by the graphics processing unit 110 to a display device (not shown in the figure) for display. In an embodiment, the audio-video connector 150 is a High-Definition Multimedia Interface (HDMI) connector or a DisplayPort (DP) connector.

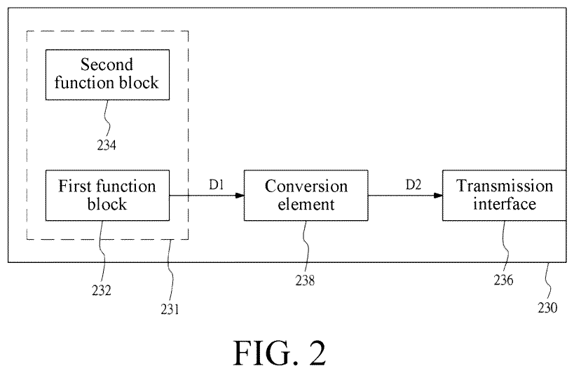

Referring to FIG. 2, FIG. 2 is a schematic block diagram of an interface device 230 according to an embodiment of the disclosure.

As shown in the figure, the interface device 230 includes a connector assembly 231, a transmission interface 236, and a conversion element 238. The connector assembly 231 includes a first function block 232 and a second function block 234.

The connector assembly 231 is arranged on an outer side 230a of the interface device 230, and supports the second bus standard.

The transmission interface 236 is arranged on an inner side 230b of the interface device 230, and data generated by the transmission interface 236 follows the first bus standard. In an embodiment, the connector assembly 231 is a universal serial bus Type-C connector, and the first function block 232 and the second function block 234 respectively support data transmission specifications of USB4 and USB2. In this way, with the first function block 232 supporting a high transmission speed, the connector assembly 231 is used as a mobile device connector to receive the first data D1. A transmission interface 236 follows a standard of peripheral component interconnect express (PCI-E) to generate the second data D2.

The conversion element 238 is electrically coupled to the transmission interface 236, and is adapted to convert the first data D1 into the second data. Bandwidth supported by the transmission interface 236 corresponds to bandwidth of the first pin group 122 in FIG. 1. Pins corresponding to the transmission interface 236 include a reset (RESET) pin, a clock signal pin, a receive pin, a transmit pin, and the like.

In an embodiment, the foregoing connector assembly 231 is used as a power supply connector to supply power to the mobile device. In an embodiment, the foregoing connector assembly 231 is further adapted to output a display signal.

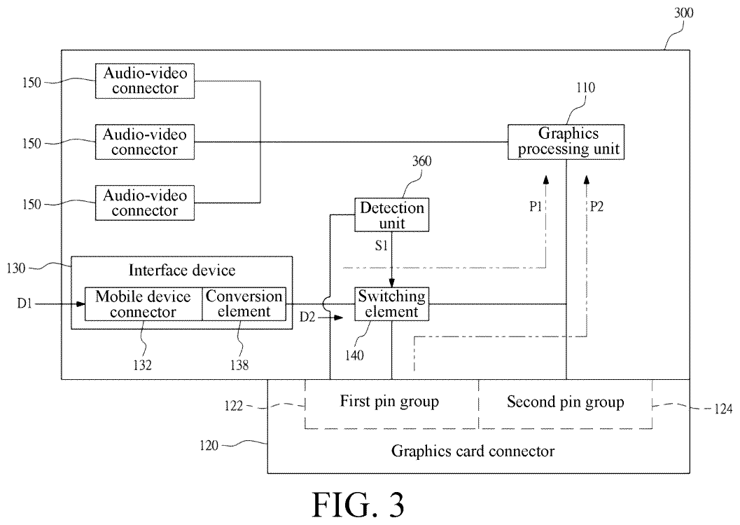

FIG. 3 is a schematic block diagram of a graphics card 300 according to another embodiment of the disclosure.

In comparison with the embodiment in FIG. 1, the graphics card 300 in this embodiment further includes a detection unit 360. The detection unit 360 is electrically coupled to the graphics card connector 120 (electrically coupled to the first pin group 122 in this embodiment). The detection unit 360 determines whether the graphics card 300 is plugged into the motherboard by detecting electric potential of a specific pin of the graphics card connector 120, and then generates the selection signal S1 to notify the switching element 140 to switch.

Specifically, when the detection unit 360 detects that the graphics card 300 is plugged into the motherboard, the detection unit 360 generates the selection signal S1 to notify the switching element 140 to conduct the data transmission path P2 between the first pin group 122 and the graphics processing unit 110, so that the graphics card 300 switches/is switched to the first operation mode.

On the contrary, when the detection unit 360 does not detect that the graphics card 300 is plugged into the motherboard, the detection unit 360 generates the selection signal S1 to notify the switching element 140 to conduct the data transmission path P1 between the conversion element 138 and the graphics processing unit 110, so that the graphics card 300 switches/is switched to the second operation mode.

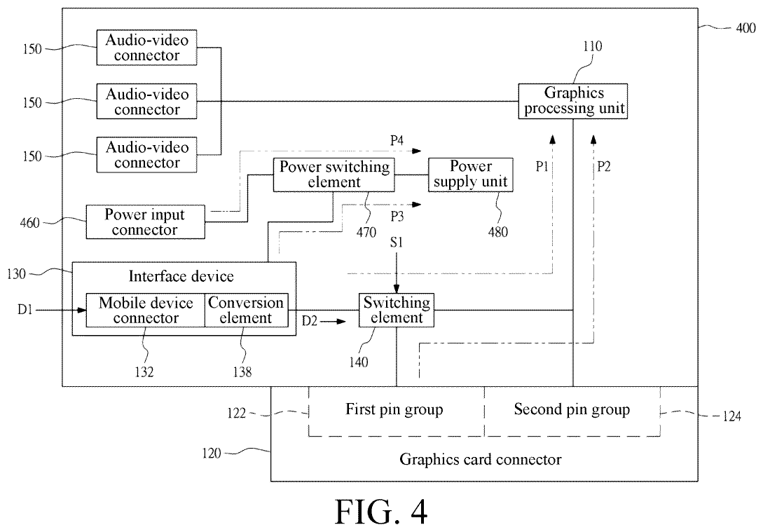

FIG. 4 is a schematic block diagram of a graphics card 400 according to still another embodiment of the disclosure.

In comparison with the embodiment in FIG. 1, the graphics card 400 in this embodiment includes a power input connector 460 and a power switching element 470. The power input connector 460 is adapted to be electrically connected to an adapter (not shown in the figure) to obtain external power supply.

The power switching element 470 is electrically coupled to the power input connector 460, the interface device 130, and a power supply unit 480. When power consumption of the graphics card 400 is lower than a power consumption threshold, the power switching element 470 conducts a power supply path P3 between the interface device 130 and the power supply unit 480, and a mobile device (in an embodiment, a notebook computer) connected to the interface device 130 supplies power to the graphics card 400. In an embodiment, the power consumption threshold is set to 50W.

When the power consumption of the graphics card 400 is higher than or equal to the power consumption threshold, the power switching element 470 conducts a power supply path P4 between the power input connector 460 and the power supply unit 480, and the adapter supplies power to the graphics card 400 instead. In this case, the power provided by the adapter further charges the mobile device (in an embodiment, a notebook computer) through the interface device 130.

It is to be noted that, switching action of the foregoing power switching element 470 is performed when the graphics card 400 operates in the second operation mode. When the graphics card 400 operates in the first operation mode (in an embodiment, the detection unit 360 in FIG. 3 detects that the graphics card 300 is plugged into the motherboard), the power switching element 470 stops operating.

In addition, the switching action of the power switching element 470 in this embodiment is mainly to switch a power source between the adapter and the mobile device. In an embodiment, when the graphics card 400 detects that the adapter is not connected, the power consumption of the graphics card 400 is limited to below the power consumption threshold, and the mobile device maintains supplying power.

The graphics cards 100, 300, and 400 provided by the disclosure each include the conversion element 138 adapted to convert the first data D1 that is from the external device and follows the second bus standard into the second data D2 that follows the first bus standard, and include the switching element 140 that selectively conducts the data transmission path P2 between the conversion element 138 and the graphics processing unit 110 or the data transmission path P1 between the first pin group 122 and the graphics processing unit 110. In this way, based on a use requirement, the graphics card is used with a desktop computer as a discrete graphics card, or is used with a notebook computer as an external graphics card, so that a plurality of graphics card devices does not need to be prepared for different use scenarios.

Although the disclosure is described with reference to the foregoing embodiments, the embodiments are not intended to limit the disclosure. A person skilled in the art makes variations and improvements without departing from the spirit and scope of the disclosure. Therefore, the protection scope of the disclosure is defined by the claims.

What is claimed is:

1. A graphics card, comprising:
a graphics processing unit;
a graphics card connector, adapted to be connected to a motherboard, wherein the graphics card connector supports a first bus standard, and comprises a first pin group;
an interface device, comprising:
a mobile device connector, adapted to be connected to a mobile device, wherein the mobile device connector supports a second bus standard, and is adapted to receive first data; and
a conversion element, electrically coupled to the mobile device connector, and adapted to convert the first data into second data, wherein the second data follows the first bus standard, and a quantity of transmission channels of the first bus standard that are supported by the conversion element is equal to a quantity of transmission channels supported by the first pin group; and
a switching element, electrically coupled to the conversion element, the first pin group, and the graphics processing unit, and adapted to selectively conduct a data transmission path between the conversion element and the graphics processing unit or a data transmission path between the first pin group and the graphics processing unit.

2. The graphics card according to claim 1, wherein the first bus standard is peripheral component interconnect express, and the second bus standard is a universal serial bus.

3. The graphics card according to claim 1, wherein the mobile device connector is a USB4 connector, a thunderbolt connector, or an OCuLink connector.

4. The graphics card according to claim 2, wherein a quantity of transmission channels supported by the graphics card connector is a first quantity, the quantity of transmission channels supported by the first pin group is a second quantity, and the first quantity is greater than the second quantity.

5. The graphics card according to claim 4, wherein the second quantity is 4, and the first quantity is 16.

6. The graphics card according to claim 4, wherein the graphics card connector comprises the first pin group and a second pin group, the first pin group is indirectly electrically connected to the graphics processing unit through the switching element, and the second pin group is directly electrically connected to the graphics processing unit.

7. The graphics card according to claim 6, wherein pins of the second pin group are all signal transmission pins, and a quantity of transmission channels supported by the second pin group is a difference between the first quantity and the second quantity.

8. The graphics card according to claim 1, wherein the interface device further comprises a connector assembly, adapted to supply power to the mobile device.

9. The graphics card according to claim 8, wherein the connector assembly supports the second bus standard.

10. The graphics card according to claim 1, wherein the switching element selectively conducts the data transmission path between the conversion element and the graphics processing unit or the data transmission path between the first pin group and the graphics processing unit based on a selection signal.

11. The graphics card according to claim 1, further comprising a detection unit, electrically coupled to the graphics card connector, and adapted to detect a plug-in state of the graphics card connector.
